(19) United States
(12) Patent Application Publication
(10) Pub. No.: US 2013/0021545 A1
(43) Pub. Date: Jan. 24, 2013

(54) SPATIAL LIGHT MODULATOR AND OPTICAL APPARATUS EMPLOYING THE SAME

(71) Applicants: Hoon SONG, Yongin-si (KR); Hong-seok Lee, Seongnam-si (KR); Kyu-hwan Choi, Yongin-si (KR)

(72) Inventors: Hoon SONG, Yongin-si (KR); Hong-seok Lee, Seongnam-si (KR); Kyu-hwan Choi, Yongin-si (KR)

(73) Assignee: Samsung Electronics Co., Ltd., Suwon-si (KR)

(21) Appl. No.: 13/553,102

(22) Filed: Jul. 19, 2012

(30) Foreign Application Priority Data
Jul. 21, 2011 (KR) 10-2011-0072568

(51) Int. Cl. G02F 1/1335; G02B 27/22; G02F 1/29

(52) U.S. Cl. 349/15; 359/315; 349/86; 359/462

(57) ABSTRACT

A spatial light modulator includes a first transparent substrate; a second transparent substrate; a phase modulation unit disposed between the first transparent substrate and the second transparent substrate and configured to modulate a phase of light passing through the phase modulation unit by changing an optical path length of the phase modulation unit according to a voltage applied to the phase modulation unit; and an amplitude modulation unit disposed between the first transparent substrate and the second transparent substrate and configured to modulate an amplitude of light passing through the amplitude modulation unit according to a voltage applied to the amplitude modulation unit.

### CROSS-REFERENCE TO RELATED APPLICATIONS

This application claims the benefit of Korean Patent Application No. 10-2011-0072568 filed on Jul. 21, 2011, in the Korean Intellectual Property Office, the disclosure of which is incorporated herein by reference in its entirety.

### BACKGROUND

1. Field

This disclosure relates to a spatial light modulator and an optical apparatus employing the same.

2. Description of the Related Art

A Spatial Light Modulator (SLM) is a device used to control a distribution of light in optical systems. The SLM may be used, for example, for holographic 3-dimensional (3D) displays, beam forming, optical filtering, etc.

Light modulation is achieved by a combination of an amplitude change and a phase change. Thus, not only phase modulation but also amplitude modulation is necessary for the light modulation. However, because most SLMs modulate only a phase or an amplitude of light, the use of an SLM for modulating only a phase or an amplitude of light causes the limit of an expression.

### SUMMARY

According to an aspect, a Spatial Light Modulator (SLM) includes a first transparent substrate; a second transparent substrate; a phase modulation unit disposed between the first transparent substrate and the second transparent substrate and configured to modulate a phase of light passing through the phase modulation unit by changing an optical path length of the phase modulation unit according to a voltage applied to the phase modulation unit; and an amplitude modulation unit disposed between the first transparent substrate and the second transparent substrate and configured to modulate an amplitude of light passing through the amplitude modulation unit by changing a transmittance of the amplitude modulation unit according to a voltage applied to the amplitude modulation unit.

The phase modulation unit may include a first control electrode disposed on one of the first transparent substrate and the second transparent substrate; and a phase modulation layer configured to modulate the phase of the light passing through the phase modulation unit by changing an optical path length of the phase modulation layer according to a voltage applied to the phase modulation layer via the first control electrode.

The phase modulation layer may include a polymer-dispersed liquid crystal layer.

The SLM may further include a protection layer disposed on the polymer-dispersed liquid crystal layer to protect the polymer-dispersed liquid crystal layer.

The voltage applied to the phase modulation layer via the first control electrode may be higher than a saturation voltage at which a transmittance of the phase modulation layer is a maximum transmittance.

The amplitude modulation unit may include a second control electrode disposed on one of the first transparent substrate and the second transparent substrate on which the first control electrode is not disposed; and an amplitude modulation layer configured to modulate the amplitude of the light passing through the amplitude modulation unit by changing a transmittance of the amplitude modulation layer according to a voltage applied to the amplitude modulation layer via the second control electrode.

The amplitude modulation layer may include a light shutter layer using an electrowetting phenomenon.

The SLM may further include a common electrode disposed between the phase modulation unit and the amplitude modulation unit.

According to an aspect, an optical apparatus include the SLM described above; and an image sensing device or a light source; wherein if the optical apparatus includes the image sensing device, the optical apparatus is an image acquisition device configured to acquire an image by sensing, using the image sensing device, light of which a phase and an amplitude have been modulated by the SLM described above; and if the optical apparatus includes the light source, the optical apparatus is a 3-dimensional (3D) display device configured to display a 3D image by modulating, using the SLM described above, a phase and an amplitude of light radiated from the light source.

According to an aspect, a Spatial Light Modulator (SLM) includes a first transparent substrate; a second transparent substrate; a phase modulation unit disposed between the first transparent substrate and the second transparent substrate and configured to modulate a phase of light passing through the phase modulation unit without changing an amplitude of the light passing through the phase modulation unit; and an amplitude modulation unit disposed between the first transparent substrate and the second transparent substrate and configured to modulate an amplitude of light passing through the amplitude modulation unit without changing a phase of the light passing through the amplitude modulation unit.

The phase modulation unit and the amplitude modulation unit may be arranged so that light passing through any portion of the SLM passes through both the phase modulation unit and the amplitude modulation unit.

One of the phase modulation unit and the amplitude modulation unit may include partitions dividing the SLM into pixel or sub-pixel units.

The phase modulation unit may be further configured to modulate the phase of the light passing through the phase modulation unit without changing the amplitude of the light passing through the phase modulation unit by changing only an optical path length of the phase modulation unit according to a voltage applied to the phase modulation unit without changing a transmittance of the phase modulation unit according to the voltage applied to the phase modulation unit.

The amplitude modulation unit may be further configured to modulate the amplitude of the light passing through the amplitude modulation unit without changing the phase of the light passing through the amplitude modulation unit by changing only a transmittance of the amplitude modulation unit according to a voltage applied to the amplitude modulation unit without changing an optical path length of the amplitude modulation unit according to the voltage applied to the amplitude modulation unit.

The phase modulation unit may include a first control electrode; and a phase modulation layer configured to modulate the phase of the light passing through the phase modulation unit by changing an optical path length of the phase modulation layer according to a voltage applied to the first control electrode without changing a transmittance of the phase modulation layer according to the voltage applied to the first control electrode.

The phase modulation layer may include a polymer-dispersed liquid crystal.

The amplitude modulation unit may include a second control electrode; and an amplitude modulation layer configured to modulate the amplitude of the light passing through the amplitude modulation unit by changing a transmittance of the amplitude modulation layer according to a voltage applied to the second control electrode without changing an optical path length of the amplitude modulation layer according to the voltage applied to the second control electrode.

The amplitude modulation layer may include a light shutter using an electrowetting phenomenon.

The SLM may include a common electrode disposed between the phase modulation unit and the amplitude modulation unit; the phase modulation layer may be disposed between the first control electrode and the common electrode; and the amplitude modulation layer may be disposed between the second control electrode and the common electrode.

The first control electrode may be disposed on a surface of the first transparent substrate facing the second transparent substrate, and the second control electrode may be disposed on a surface of the second transparent substrate facing the first transparent; or the first control electrode may be disposed on the surface of the second transparent substrate facing the first transparent substrate, and the second control electrode may be disposed on the surface of the first transparent substrate facing the second transparent substrate.

Additional aspects will be set forth in part in the description that follows and, in part, will be apparent from the description, or may be learned by practice of the described examples.

### BRIEF DESCRIPTION OF THE DRAWINGS

The above and other aspects will become apparent and more readily appreciated from the following description of examples, taken in conjunction with the accompanying drawings in which:

FIG. 1 is a schematic cross-sectional diagram of a Spatial Light Modulator (SLM) according to an example;

FIGS. 2A to 2C are schematic cross-sectional diagrams for describing light dispersion, light transmission, and phase modulation processes according to a magnitude of a voltage applied to the phase modulation layer of FIG. 1;

FIGS. 3A and 3B are schematic cross-sectional diagrams for describing an operation of the amplitude modulation unit of FIG. 1; and

FIG. 4 is a schematic diagram of an optical apparatus to which the SLM of FIG. 1 is applied according to an example.

### DETAILED DESCRIPTION

A light modulator and an optical apparatus employing the same according to examples will now be described more fully with reference to the accompanying drawings, in which examples are shown. In the drawings, the widths and thicknesses of layers and regions may be exaggerated for clarity. Like reference numerals refer to like elements throughout the detailed description and the drawings.

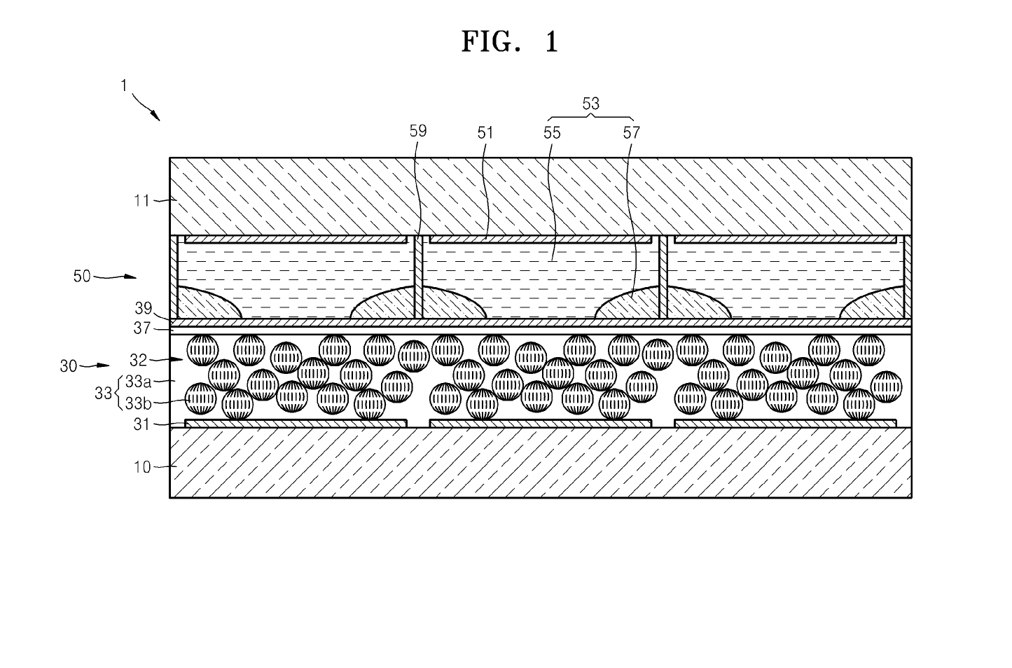

FIG. 1 is a schematic cross-sectional diagram of a spatial light modulator (SLM) 1 according to an example. Referring to FIG. 1, the SLM 1 includes first and second transparent substrates 10 and 11, and a phase modulation unit 30 and an amplitude modulation unit 50 disposed between the first and second transparent substrates 10 and 11.

In general, a glass substrate or a transparent plastic substrate may be used as the first and second transparent substrates 10 and 11. The first and second transparent substrates 10 and 11 may be the same type of substrate, or may be different types of substrates.

The phase modulation unit 30 is formed to modulate a phase of light passing therethrough by changing an optical path length of the phase modulation unit according to a voltage applied to the phase modulation unit 30. The phase modulation unit 30 includes a first control electrode 31 disposed on any one, e.g., the first transparent substrate 10 as shown in FIG. 1, of the first and second transparent substrates 10 and 11, and a phase modulation layer 32 for modulating a phase of light passing therethrough by changing an optical path length of the phase modulation layer 32 according to a voltage applied to the phase modulation layer 32 via the first control electrode 31. The phase modulation unit 30 may further include a common electrode 39 that is commonly used by the amplitude modulation unit 50. As shown in FIG. 1, the common electrode 39 may be disposed to face the first control electrode 31 on an opposite surface of the phase modulation layer 32. The phase modulation unit 30 and the amplitude modulation unit 50 may be formed to use respective electrodes instead of using the common electrode 39.

The first control electrode 31 and the common electrode 39 are transparent electrodes and may be formed using, for example, a transparent conductive inorganic material, such as Indium Tin Oxide (ITO) or ZnO. A transparent conductive inorganic material or a transparent conductive organic material may be used as the first control electrode 31. That is, the first control electrode 31 and the common electrode 39 may be formed using the same material or different materials.

In addition, the first control electrode 31 may be formed as stripes, and the common electrode 39 may be formed as stripes crossing the stripes of the first control electrode 31. Areas in which the stripes of the first control electrode 31 and the stripes of the common electrode 39 cross each other may correspond to pixels or sub-pixels. The first control electrode 31 and the common electrode 39 may be formed to have different shapes. For example, the first control electrode 31 may be formed to have a shape corresponding to each pixel or sub-pixel, and the common electrode 39 may be formed to have a shape covering the entire surface of the phase modulation unit 30.

The phase modulation layer 32 may include a polymer-dispersed liquid crystal layer (PDLC) layer 33. The PDLC layer 33 may be produced as a film by mixing a polymer 33a and a liquid crystal so that liquid crystal droplets 33b are randomly dispersed in the polymer 33a. The PDLC layer 33 may be formed by nematic liquid crystals and monomer of bisphenol A dimethacrylate, 2-hydroxy-2-methyl-1-phenyl-1-propaneone. Materials suitable for use in the PDLC layer 33 are well known to one of ordinary skill in the art, and thus will not be described here. When the phase modulation layer 32 is formed as a film, another component, e.g., the amplitude modulation unit 50, may be integrated on the phase modulation layer 32, thereby simplifying the manufacturing of the SLM 1.

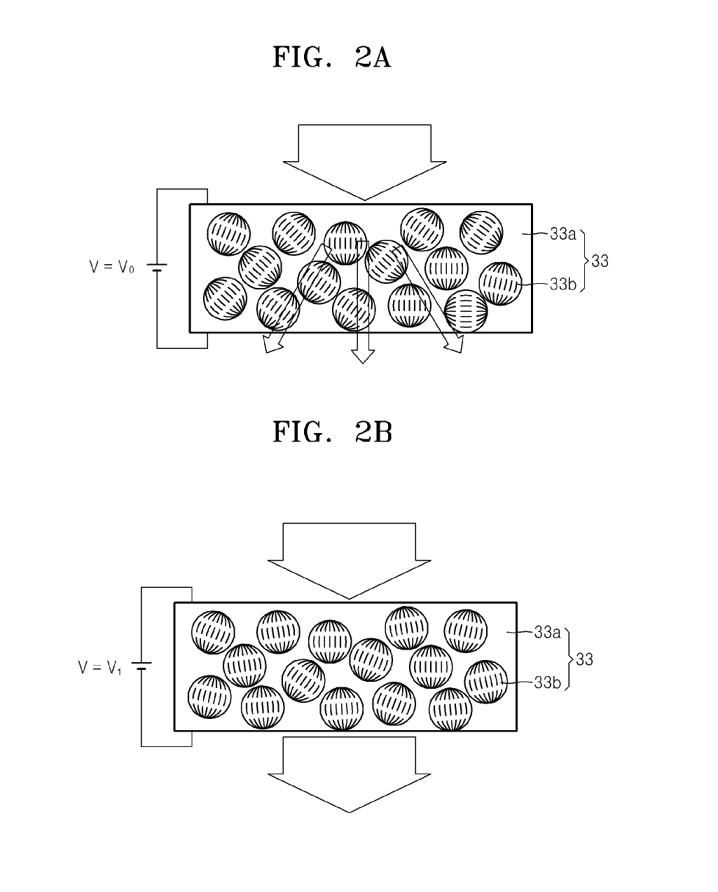

When the PDLC layer 33 is included in the phase modulation unit 30 as the phase modulation layer 32 as described above and no voltage is applied to the PDLC layer 33 (V=0), or a voltage not high enough to start to align the liquid crystal directors of the liquid crystal droplets 33b with an electric field in the PDLC layer 33 is applied to the PDLC layer 33, i.e., a voltage that smaller than a threshold voltage of the PDLC layer 33, as shown in FIG. 2A, the PDLC layer 33 disperses incident light due to a difference between a refractive index of the polymer 33a and a refractive index of the liquid crystal droplets 33b. V₀ shown in FIG. 2A denotes 0 V or a voltage lower than the threshold voltage required to start to align the liquid crystal directors of the liquid crystal droplets 33b with the electric field in the PDLC layer 33.

When a predetermined voltage V₁ high enough to align the liquid crystal directors of the liquid crystal droplets 33b with the electric field in the PDLC layer 33 is applied to the PDLC layer 33, as shown in FIG. 2B, thereby making the refractive index of the liquid crystal of the liquid crystal droplets 33b almost the same as the refractive index of the polymer 33a, incident light is transmitted through the PDLC layer 33 without dispersion.

As shown in FIGS. 2A and 2B, the PDLC layer 33 acts as a light shutter for allowing or blocking the transmission of light according to whether a voltage applied to the PDLC layer 33 is V₁ or V₀.

When a saturation voltage higher than the predetermined voltage V₁ is applied to the PDLC layer 33, as shown in FIG. 2C, a transmittance of the PDLC layer 33 becomes saturated. That is, a transmittance of the PDLC layer reaches a maximum transmittance at the saturation voltage that does not continue to increase even if a voltage V applied to the PDLC layer 33 is increased above the saturation voltage. When a voltage higher than the saturation voltage for saturating the transmittance is applied to the PDLC layer 33, although the transmittance remains constant, an entire refractive index of the polymer 33a and the liquid crystal droplets 33b varies according to the voltage, and thus an optical path length of the PDLC layer 33 varies according to the voltage. For example, when V₂ denotes the saturation voltage for saturating a transmittance and is higher than the predetermined voltage V₁, by increasing a voltage V applied to the PDLC layer 33 to be higher than V₂, the optical path length of the PDLC layer 33 is changed according to the voltage V even though the transmittance is saturated. Since a change in optical patch length produces a change in phase, a phase of light passing through the phase modulation unit 30 may be modulated by adjusting a magnitude of a voltage applied to the PDLC layer 33. Accordingly, by modulating the phase of light by adjusting the magnitude of a voltage applied to the PDLC layer 33 for each pixel or sub-pixel, the SLM 1 may be operated as a phase SLM.

As described above, when the SLM 1 operates as a phase SLM, a voltage applied to the phase modulation layer 32 via the first control electrode 31 is a voltage higher than the saturation voltage V₂ for saturating a transmittance of the PDLC layer 33.

Since the PDLC layer 33 is used as the phase modulation layer 32 of the SLM 1, because a phase is determined by an average refractive index obtained from the refractive index of the liquid crystal of the liquid crystal droplets 33b and the refractive index of the polymer 33a, the use of a polarizer is unnecessary, unlike in conventional SLMs using a general liquid crystal, so the light efficiency of the SLM 1 is higher than conventional SLMs. In addition, because the SLM 1 is used only under a condition in which the transmittance of the PDLC layer 33 is a maximum transmittance and does not change, the PDLC layer 33 may modulate only a phase of light.

Referring back to FIG. 1, the SLM 1 further includes a protection layer 37 for protecting the PDLC layer 33 disposed on the PDLC layer 33. However, the protection layer 37 may be omitted.

The amplitude modulation unit 50 is formed to modulate an amplitude of light by changing a transmittance of the amplitude modulation unit 50 according to a voltage applied thereto.

The amplitude modulation unit 50 includes a second control electrode 51 disposed on an inner surface of the other one, e.g., the second transparent substrate 11, of the first and second transparent substrates 10 and 11 on which the first transparent electrode 31 is not disposed, and an amplitude modulation layer 53 for modulating an amplitude of light by adjusting a transmittance of the amplitude modulation layer according to a voltage applied to the amplitude modulation layer 53 through the second control electrode 51. The amplitude modulation unit 50 may further include the common electrode 39 described above.

The second electrode 51 may be disposed to face the common electrode 39 on an opposite surface of the amplitude modulation layer 53. Similar to the first control electrode 31 and the common electrode 39, the second control electrode 51 is a transparent electrode and may be formed using, for example, a transparent conductive inorganic material, such as ITO or ZnO. A transparent conductive inorganic material or a transparent conductive organic material may be used as the second control electrode 51. The second control electrode 51 and the common electrode 39 may be formed using the same material or different materials.

A relationship between the second control electrode 51 and the common electrode 39 may be the same as that between the first control electrode 31 and the common electrode 39. That is, the second control electrode 51 may be formed as stripes. When the common electrode 39 is formed in stripes crossing the stripes of the first control electrode 31 as described above, the second control electrode 51 may be formed as stripes crossing the stripes of the common electrode 39 and parallel to the stripes of the first control electrode 31. Thus, when the common electrode 39 formed as stripes is commonly used, the first control electrode 31 and the second control electrode 51 may be formed in substantially the same shape. Areas in which the stripes of the second control electrode 51 and the stripes of the common electrode 39 cross each other may correspond to pixels or sub-pixels. The second control electrode 51 and the common electrode 39 may be formed to have different shapes. For example, the second control electrode 51 may be formed to have a shape corresponding to each pixel or sub-pixel, and the common electrode 39 may be formed to have a shape covering the entire surface of the amplitude modulation unit 50.

Although the phase modulation unit 30 and the amplitude modulation unit 50 share the common electrode 39 in FIG. 1, this is only an example, and the phase modulation unit 30 and the amplitude modulation unit 50 may include separate electrodes instead of the common electrode 39. In addition, although the first control electrode 31 and the second control electrode 51 are disposed on the inner surfaces of the first and second transparent substrates 10 and 11 in FIG. 1, respectively, if the separate electrodes are included in the phase modulation unit 30 and the amplitude modulation unit 50 instead of the common electrode 39, the separate electrodes may be disposed on the inner surfaces of the first and second transparent substrates 10 and 11, and the first control electrode 31 and the second control electrode 51 may be disposed between the phase modulation layer 32 and the amplitude modulation layer 53. In addition, although the SLM 1 in FIG. 1 is formed in an order of the first transparent substrate 10, the phase modulation unit 30, the amplitude modulation unit 50, and the second transparent substrate 11, this is only an example, and positions of the phase modulation unit 30 and the amplitude modulation unit 50 may be exchanged with each other. As will be apparent to one of ordinary skill in the art, other modifications may be made to the structure of the SLM 1 in addition to the modifications described above.

The amplitude modulation layer 53 modulates an amplitude of light passing through the amplitude modulation unit 50 by changing only a transmittance of the amplitude modulation layer 53 according to a voltage applied thereto without changing a phase of the light passing through the amplitude modulation unit 50, and includes, for example, a light shutter layer using an electrowetting phenomenon.

That is, the amplitude modulation layer 53 consists of a solution including a transparent aqueous solution 55 and an organic solution 57 that is opaque filled in a space between the second control electrode 51 and the common electrode 39. Distilled water or an aqueous solution in which an electrolyte is dissolved may be used as the aqueous solution 55. The organic solution 57 has a hydrophobic property exhibiting the electrowetting phenomenon. Since the organic solution 57 is opaque and therefore is able to block all of incident red (R) light, green (G) light, and blue (B) light, the organic solution 57 includes an inorganic or organic material for blocking the red (R) light, green (G) light, and blue (B) light. An example of the inorganic material is carbon black, and examples of the organic material are an organic dye and an organic pigment. Black oil, for example, may be used as the organic solution 57. Black ink may be used as the black oil, and may include carbon black. The organic solution 57 may further include color filter materials currently used in Liquid Crystal Displays (LCDs), such as red (R), green (G), and blue (B) filter materials, dissolved in a transparent organic substance such as an oil to provide color filters in respective pixels or sub-pixels.

The entire surface of the common electrode 39 facing the amplitude modulation layer 53 is processed to have a hydrophobic property. For example, the entire surface of the common electrode 39 facing the amplitude modulation layer 53 may be coated with a hydrophobic polymer. Alternatively, a dielectric layer (not shown) having a hydrophobic property may be disposed on the entire surface of the common electrode 39 facing the amplitude modulation layer 53. The dielectric layer consists of one or more transparent materials, and is formed so that a surface of the dielectric layer has a hydrophobic property. For example, the dielectric layer may include a fluoropolymer or Parylene as an organic material, and silicon dioxide (SiO₂) or Barium Strontium Titanate (BST) as an inorganic material. When the dielectric layer includes a layer of SiO₂ or BST disposed on the entire surface of the common electrode 39 facing the amplitude modulation layer 53, the organic material, e.g., a fluoropolymer or Parylene, is coated on a surface of the dielectric layer facing the amplitude modulation layer 53 to provide a sufficient hydrophobic property to the surface of the dielectric layer facing the amplitude modulation layer 53.

Although a case where hydrophobic processing is performed on the entire surface of the common electrode 39 facing the amplitude modulation layer 53, or a dielectric layer having a hydrophobic property is disposed on the entire surface of the common electrode 39 facing the amplitude modulation layer 53 has been described, hydrophobic processing may be performed on the entire surface of the second control electrode 51 facing the amplitude modulation layer 53, or a dielectric layer having a hydrophobic property may be disposed on the entire surface of the second control electrode 51 facing the amplitude modulation layer 53, or hydrophobic processing may be performed on the entire surface of both the common electrode 39 and the second control electrode 51 facing the amplitude modulation layer 53, or a dielectric layer having a hydrophobic property may be disposed on the entire surface of both the common electrode 39 and the second control electrode 51 facing the amplitude modulation layer 53. In the description of FIG. 1 and below, a case where hydrophobic processing is performed on the entire surface of the common electrode 39 facing the amplitude modulation layer 53 is described.

A plurality of partitions 59 are disposed in an area between the first and second transparent substrates 10 and 11 in which the amplitude modulation layer 53 is formed. These partitions 59 maintain a constant distance between the first and second transparent substrates 10 and 11, enable the amplitude modulation layer 53 in which a solution is filled to be formed, and partition the amplitude modulation layer 53 in which a solution is filled into compartments respectively corresponding to pixels or sub-pixels. The plurality of partitions 59 are disposed between segments of the second control electrode 51 respectively corresponding to pixels or sub-pixels.

In the amplitude modulation unit 50 having the structure described above, i.e., the light shutter using the electrowetting phenomenon, when a predetermined voltage is applied between the second control electrode 51 and the common electrode 39, the hydrophobic surface of the common electrode 39 (or the dielectric layer in a case where the dielectric layer is disposed on the common electrode 59) is changed to have a hydrophilic property. Accordingly, an area in which the aqueous solution 55 contacts the surface of the common electrode 39 increases, and the organic solution 57 moves towards edges of each pixel or sub-pixel, i.e., towards each partition 59, thereby increasing an area through which light passes, thereby increasing an amount of light passing through the amplitude modulation layer 53, thereby increasing a transmittance of the amplitude modulation layer 53.

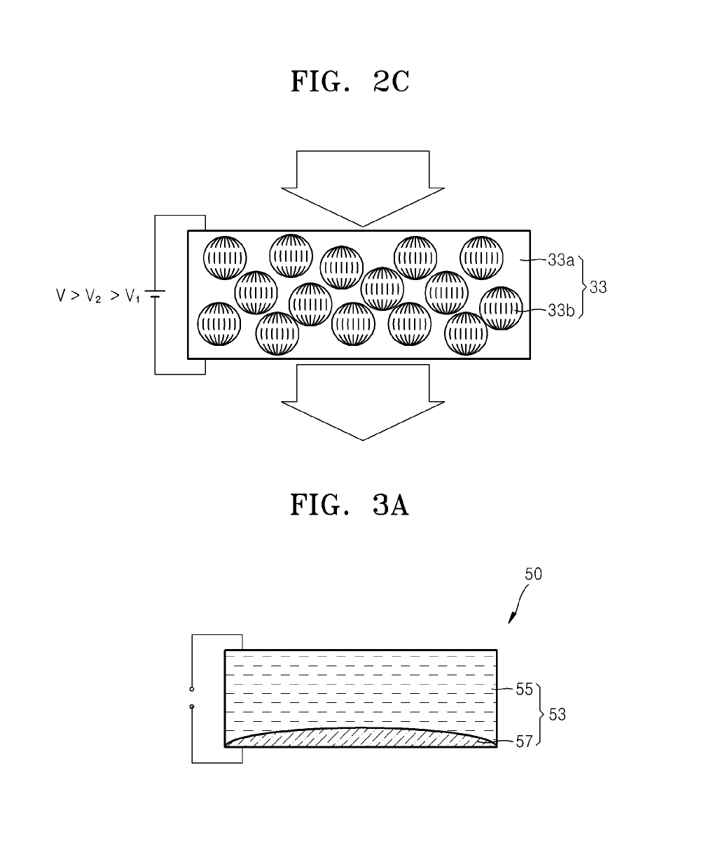

FIGS. 3A and 3B are schematic cross-sectional diagrams for describing an operation of the amplitude modulation unit 50. FIG. 3A shows a state in which no voltage is applied between the second control electrode 51 and the common electrode 39, and FIG. 3B shows a state in which a predetermined voltage is applied between the second control electrode 51 and the common electrode 39.

Referring to FIG. 3A, when no voltage is applied between the second control electrode 51 and the common electrode 39, because a sum of an interface energy between the organic solution 57 and the aqueous solution 55 and an interface energy between the organic solution 57 and the surface of the common electrode 39 having a hydrophobic property (hereinafter referred to as “the hydrophobic surface”) is less than an interface energy between the aqueous solution 55 and the hydrophobic surface, the organic solution 57 covers the entire hydrophobic surface, and the aqueous solution 55 is disposed on the organic solution 57. Accordingly, incident light is blocked by the organic solution 57 that is opaque so that the incident light is not transmitted through the amplitude modulation layer 53.

Referring to FIG. 3B, if a predetermined voltage is applied between the second control electrode 51 and the common electrode 39, a contact characteristic between the hydrophobic surface and the organic solution 57 is changed. For example, the hydrophobic surface is changed to a hydrophilic surface, and accordingly an area in which the aqueous solution 55 contacts the hydrophilic surface increases. Therefore, the organic solution 57 moves towards areas to which the predetermined voltage is not applied, i.e., towards each partition 59. As a result, because incident light is transmitted through the transparent aqueous solution 55 in each pixel or sub-pixel, the incident light is transmitted through the amplitude modulation layer 53. When a hydrophilic characteristic of the surface of the common electrode 39 increases by increasing a voltage applied between the second control electrode 51 and the common electrode 39 within a predetermined range, the area in which the aqueous solution 55 contacts the hydrophilic surface increases even more, thereby increasing an amount of the incident light that is transmitted through the amplitude modulation layer 53, therefore increasing a transmittance of the amplitude modulation layer 53. Thus, the transmittance of the amplitude modulate layer 53 changes according to the voltage applied between the second control electrode 51 and the common electrode 39.

Thus, an amount of light passing through the amplitude modulation layer 53 may be modulated by changing a magnitude of a voltage applied between the second control electrode 51 and the common electrode 39 to change a transmittance of the amplitude modulation layer 53.

The SLM 1, which is a device capable of separately adjusting an amplitude and a phase of light, i.e., a device that is a hybrid of a phase SLM and an amplitude SLM in a single body, may be implemented by integrating the phase modulation layer 32, such as the PDLC layer 33, which is a phase SLM that changes only a phase of light without changing an amplitude of light, with the amplitude modulation layer 53, e.g., the light shutter using the electrowetting phenomenon, which is an amplitude SLM that changes only an amplitude of light without changing a phase of light, and may be control light in pixel or sub-pixel units.

Because the phase SLM and the amplitude SLM of the SLM 1 can be integrated in an integration process, an additional operation of aligning the phase SLM with the amplitude SLM is not required when manufacturing the SLM 1, and because the phase SLM controls only a phase of light and the amplitude SLM controls only an amplitude of light, there is no interference between the phase SLM and the amplitude SLM. In addition, because a distance between the phase SLM and the amplitude SLM may be reduced by using a film protection layer such as the protection layer 37, crosstalk between adjacent pixels or subpixels due to divergence of light in the SLM 1 may be minimized.

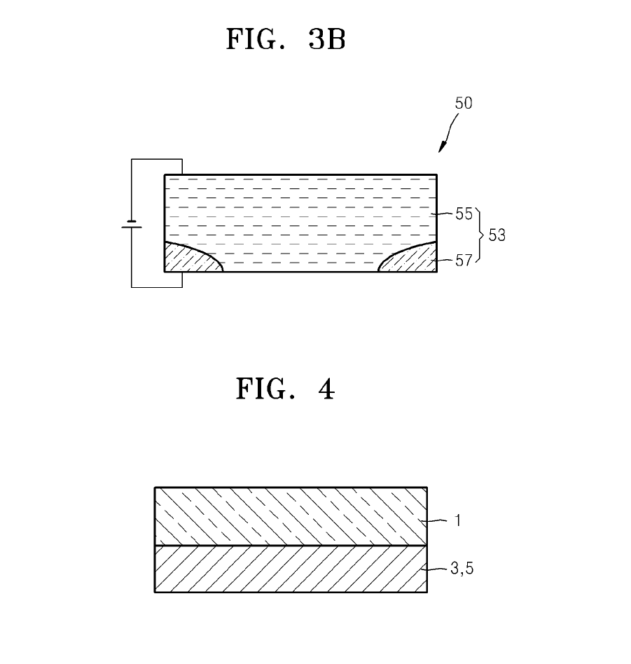

FIG. 4 is a schematic diagram of an optical apparatus to which the SLM 1 is applied according to an example. Referring to FIG. 4, the optical apparatus to which the SLM 1 is applied may be an image acquisition apparatus, e.g., a camera, for acquiring an image by sensing, using an image pickup device 3, light of which a phase and an amplitude of light have been modulated by the SLM 1, or a 3D display device for displaying a 3D image by modulating, using the SLM 1, a phase and an amplitude of light radiated from a light source 5 (the light source 5 may be an external light source or a backlight unit).

As described above, according to the examples, an SLM is implemented as a single hybrid structure in which a phase light modulator and an amplitude light modulator are formed on a substrate in a structure in which a phase modulation unit and an amplitude modulation unit are layered.

While this disclosure has been particularly shown and described with reference to examples thereof, it will be understood by those skilled in the art that various changes in form and details may be made in these examples without departing from the spirit and scope of the invention as defined by the claims and their equivalents. It should be understood that the examples described herein should be considered in a descriptive sense only, and not for purposes of limitation. Descriptions of features or aspects in each example are to be considered as being applicable to similar features or aspects in other examples. Suitable results may be achieved if the described techniques are performed in a different order and/or if components in a described system, architecture, device, or circuit are combined in a different manner and/or replaced or supplemented by other components or their equivalents. Therefore, the scope of the invention is defined not by the detailed description of the disclosure, but by the claims and their equivalents, and all variations within the scope of the claims and their equivalents are to be construed as being included in the invention.

What is claimed is:

1. A Spatial Light Modulator (SLM) comprising:
a first transparent substrate;
a second transparent substrate;
a phase modulation unit disposed between the first transparent substrate and the second transparent substrate and configured to modulate a phase of light passing through the phase modulation unit by changing an optical path length of the phase modulation unit according to a voltage applied to the phase modulation unit; and
an amplitude modulation unit disposed between the first transparent substrate and the second transparent substrate and configured to modulate an amplitude of light passing through the amplitude modulation unit by changing a transmittance of the amplitude modulation unit according to a voltage applied to the amplitude modulation unit.

2. The SLM of claim 1, wherein the phase modulation unit comprises:
a first control electrode disposed on one of the first transparent substrate and the second transparent substrate; and
a phase modulation layer configured to modulate the phase of the light passing through the phase modulation unit by changing an optical path length of the phase modulation layer according to a voltage applied to the phase modulation layer via the first control electrode.

3. The SLM of claim 2, wherein the phase modulation layer comprises a polymer-dispersed liquid crystal layer.

4. The SLM of claim 3, further comprising a protection layer disposed on the polymer-dispersed liquid crystal layer to protect the polymer-dispersed liquid crystal layer.

5. The SLM of claim 3, wherein the voltage applied to the phase modulation layer via the first control electrode is higher than a saturation voltage at which a transmittance of the phase modulation layer is a maximum transmittance.

6. The SLM of claim 2, wherein the amplitude modulation unit comprises:
a second control electrode disposed on one of the first transparent substrate and the second transparent substrate on which the first control electrode is not disposed; and
an amplitude modulation layer configured to modulate the amplitude of the light passing through the amplitude modulation unit by changing a transmittance of the amplitude modulation layer according to a voltage applied to the amplitude modulation layer via the second control electrode.

7. The SLM of claim 6, wherein the amplitude modulation layer comprises a light shutter layer using an electrowetting phenomenon.

8. The SLM of claim 7, further comprising a common electrode disposed between the phase modulation unit and the amplitude modulation unit.

9. The SLM of claim 6, further comprising a common electrode disposed between the phase modulation unit and the amplitude modulation unit.

10. An optical apparatus comprising:
the SLM of claim 1; and
an image sensing device or a light source;
wherein if the optical apparatus comprises the image sensing device, the optical apparatus is an image acquisition device configured to acquire an image by sensing, using the image sensing device, light of which a phase and an amplitude have been modulated by the SLM of claim 1; and
if the optical apparatus comprises the light source, the optical apparatus is a 3-dimensional (3D) display device configured to display a 3D image by modulating, using the SLM of claim 1, a phase and an amplitude of light radiated from the light source.

11. The optical apparatus of claim 10, wherein the phase modulation unit comprises:
a first control electrode disposed on one of the first transparent substrate and the second transparent substrate; and
a phase modulation layer configured to modulate the phase of the light passing through the phase modulation unit by changing an optical path length of the phase modulation layer according to a voltage applied to the phase modulation layer via the first control electrode.

12. The optical apparatus of claim 11, wherein the phase modulation layer comprises a polymer-dispersed liquid crystal layer.

13. The optical apparatus of claim 12, further comprising a protection layer disposed on the polymer-dispersed liquid crystal layer to protect the polymer-dispersed liquid crystal layer.

14. The optical apparatus of claim 12, wherein the voltage applied to the phase modulation layer via the first control electrode is higher than a saturation voltage at which a transmittance of the phase modulation layer is a maximum transmittance.

15. The optical apparatus of claim 11, wherein the amplitude modulation unit comprises:
a second control electrode disposed on the one of the first transparent substrate and the second transparent substrate on which the first control electrode is not disposed; and
an amplitude modulation layer configured to modulate the amplitude of the light passing through the amplitude modulation unit by changing a transmittance of the amplitude modulation layer according to a voltage applied to the amplitude modulation layer via the second control electrode.

16. The optical apparatus of claim 15, wherein the amplitude modulation layer comprises a light shutter layer using an electrowetting phenomenon.

17. The optical apparatus of claim 16, further comprising a common electrode disposed between the phase modulation unit and the amplitude modulation unit.

18. The optical apparatus of claim 15, further comprising a common electrode disposed between the phase modulation unit and the amplitude modulation unit.

19. A Spatial Light Modulator (SLM) comprising:
a first transparent substrate;
a second transparent substrate;
a phase modulation unit disposed between the first transparent substrate and the second transparent substrate and configured to modulate a phase of light passing through the phase modulation unit without changing an amplitude of the light passing through the phase modulation unit; and
an amplitude modulation unit disposed between the first transparent substrate and the second transparent substrate and configured to modulate an amplitude of light passing through the amplitude modulation unit without changing a phase of the light passing through the amplitude modulation unit.

20. The SLM of claim 19, wherein the phase modulation unit and the amplitude modulation unit are arranged so that light passing through any portion of the SLM passes through both the phase modulation unit and the amplitude modulation unit.

21. The SLM of claim 19, wherein one of the phase modulation unit and the amplitude modulation unit comprises partitions dividing the SLM into pixel or sub-pixel units.

22. The SLM of claim 19, wherein the phase modulation unit is further configured to modulate the phase of the light passing through the phase modulation unit without changing the amplitude of the light passing through the phase modulation unit by changing only an optical path length of the phase modulation unit according to a voltage applied to the phase modulation unit without changing a transmittance of the phase modulation unit according to the voltage applied to the phase modulation unit.

23. The SLM of claim 19, wherein the amplitude modulation unit is further configured to modulate the amplitude of the light passing through the amplitude modulation unit without changing the phase of the light passing through the amplitude modulation unit by changing only a transmittance of the amplitude modulation unit according to a voltage applied to the amplitude modulation unit without changing an optical path length of the amplitude modulation unit according to the voltage applied to the amplitude modulation unit.

24. The SLM of claim 19, wherein the phase modulation unit comprises:
a first control electrode; and
a phase modulation layer configured to modulate the phase of the light passing through the phase modulation unit by changing an optical path length of the phase modulation layer according to a voltage applied to the first control electrode without changing a transmittance of the phase modulation layer according to the voltage applied to the first control electrode.

25. The SLM of claim 24, wherein the phase modulation layer comprises a polymer-dispersed liquid crystal.

26. The SLM of claim 24, wherein the amplitude modulation unit comprises:
a second control electrode; and
an amplitude modulation layer configured to modulate the amplitude of the light passing through the amplitude modulation unit by changing a transmittance of the amplitude modulation layer according to a voltage applied to the second control electrode without changing an optical path length of the amplitude modulation layer according to the voltage applied to the second control electrode.

27. The SLM of claim 26, wherein the amplitude modulation layer comprises a light shutter using an electrowetting phenomenon.

28. The SLM of claim 26, further comprising a common electrode disposed between the phase modulation unit and the amplitude modulation unit;
wherein the phase modulation layer is disposed between the first control electrode and the common electrode; and
the amplitude modulation layer is disposed between the second control electrode and the common electrode.

29. The SLM of claim 28, wherein the first control electrode is disposed on a surface of the first transparent substrate facing the second transparent substrate, and the second control electrode is disposed on a surface of the second transparent substrate facing the first transparent; or
the first control electrode is disposed on the surface of the second transparent substrate facing the first transparent substrate, and the second control electrode is disposed on the surface of the first transparent substrate facing the second transparent substrate.
